(19) United States
(12) Patent Application Publication
(10) Pub. No.: US 2025/0274717 A1
(43) Pub. Date: Aug. 28, 2025

(54) METHOD AND DEVICE FOR COMPRESSING A DYNAMIC RANGE OF AN AUDIO SIGNAL

(71) Applicant: Absolute Audio Labs B.V., Leiden (NL)

(72) Inventor: Johannes LIJZENGA, Nij-Altoenae (NL)

(21) Appl. No.: 18/857,882

(22) PCT Filed: Apr. 20, 2023
(86) PCT No.: PCT/NL2023/050211

§ 371 Date: Oct. 18, 2024

(30) Foreign Application Priority Data
Apr. 20, 2022 (NL) 2031643

(51) Int. Cl. H04R 25/00

(52) U.S. Cl. CPC H04R 25/505; H04R 25/70; H04R 2430/01

(57) ABSTRACT

410- The disclosure relates to a method for compressing a dynamic range of an audio signal in a wearable audio device. The wearable audio device may for example be a hearing aid, or earphone having an in-car component, e.g. an earbud, for being inserted into a hearing canal of a user or over car headphone etc. The method comprises determining a frequency spectrum of the audio signal over a plurality of frequency bands. For each of the plurality of frequency bands a magnitude value of the frequency spectrum is determined. The magnitude values are adjusted according to a predetermined frequency band-specific compression control function. The frequency band-specific compression control functions are user-specific.

### FIELD

The invention relates to a method and wearable audio device for dynamic range compression of an audio signal.

### BACKGROUND

Many hearing impairments include a significant reduction of a dynamic range of hearing, which is predominantly caused by a significant elevation of an auditory threshold. A sound level of uncomfortable loudness may have changed as well, however typically not as substantial as the auditory threshold.

Hearing aids process audio signals by amplifying low level sounds to above the auditory threshold while also reducing high level sounds to below the upper limit of discomfort. Such process of adjusting the dynamic range of an audio signal is known as dynamic range compression. Modern hearing aids can apply multiband compression, in which a frequency spectrum of an audio signal is split into multiple frequency bands, and each frequency band is modified separately. Single and multiband compression are however prone to introducing distortions to the compressed audio signal. The well-known distortions arise mainly from “attack & release” type compression.

### SUMMARY

It is an aim to provide an improved dynamic range compression method and wearable audio device, particularly a hearing aid, configured for executing the improved dynamic range compression method.

Accordingly, a method for compressing a dynamic range of an audio signal in a wearable audio device is provided. The wearable audio device may for example be a hearing aid, or earphone having an in-ear component, e.g. an earbud, for being inserted into a hearing canal of a user. The method comprises determining a frequency spectrum of the audio signal over a plurality of frequency bands. For each of the plurality of frequency bands a magnitude value of the frequency spectrum is determined. The magnitude values are adjusted according to a predetermined frequency band-specific compression control function. The frequency band-specific compression control functions are user-specific. Hence, the compression of the audio signal is tailored to the dynamic hearing range of the user. Each person may have a unique dynamic hearing range as a function of frequency. For example, a user's dynamic hearing range at higher frequencies may be smaller than at lower frequencies. The method enables for modifying the audio signal corresponding to the user-specific dynamic hearing range. As a result, a modified audio signal may be determined which is perceived naturally by the user.

The wearable audio device may for instance include an analog-to-digital converter, for converting an analog audio signal, e.g. an acoustic speech signal, to a digital audio signal. The digital audio signal may be modified, e.g. compressed, in the temporal and/or the spectral domain, and subsequently be converted to a modified analog audio signal by a digital-to-analog converter.

The audio signal may be separated into multiple overlapping or non-overlapping a frames. The multiple frames may be processed consecutively.

Each frequency band-specific compression control function may for example include a gain function that defines gain values as a function of amplitude. Said gain values may be selectively applied to the magnitude value of the audio signal for that corresponding frequency band. Low magnitude values may for example be passed through unaltered by applying unity gain (gain equal to 1), whereas high magnitude values may for example be decreased by applying a gain less than unity. A compression control function may hence be nonlinear. The magnitude value of the audio signal (e.g. expressed in dB) at which the gain changes, is herein referred to as a knee point. Magnitude values below (or equal to) the knee point may have unity gain associated therewith, whereas magnitude values above the knee point may have a gain less than unity associated therewith.

The aspect may hence provide a method for compressing a dynamic range of an audio signal in a wearable audio device, such as a hearing aid, comprising: dividing the audio signal into a plurality of time frames; converting each time frame to the spectral domain; for each timeframe in the spectral domain, determining a magnitude spectrum; adjusting the magnitude spectrum in the spectral domain according to a predetermined frequency band-specific compression control function, wherein the band-specific compression control function is user-specific. After adjustment of the magnitude spectrum, each time frame may be converted from the spectral domain to the temporal domain, for forming the modified audio signal to be outputted to the user. The converting to the spectral domain may involve a Fourier transformation, e.g. executed by an FFT algorithm. The converting to the temporal domain may involve an inverse Fourier transformation, e.g. executed by an IFFT algorithm.

Optionally, the audio signal may be divided into a plurality of finite-length time frames, wherein each of the plurality of time frames is, or spans, at most five milliseconds, such as in a range of two to four milliseconds, e.g. two milliseconds, three milliseconds or four milliseconds. While relatively short time frames may provide a relatively low spectral resolution, it does enable a fast temporal response of the compression. Such relatively short frames furthermore allow for quick, e.g. real-time, compression that quickly responds to level changes in the audio signal. The relatively short length of the time frames, such as less than five milliseconds, furthermore minimizes temporal distortions when processing the audio signal in the spectral domain. Processing of the digital audio signal in the spectral domain may involve filtering of the spectral magnitudes only, and leaving the spectral phase unaltered. Using short time frames minimizes the disassociation between processed amplitude and the unaltered phase.

Optionally, the band-specific compression control functions are predetermined based on a measured audiogram of a user of the wearable audio device. An audiogram reflects the auditory threshold of a user for a range of standardized frequencies. The audiogram can be measured by a so-called audiometer. Alternatively, or additionally, the user-specific frequency-dependent compression function may be based on a measured equal-loudness contour of a user of the wearable audio device. The method may include determining a measure of hearing loss of the user per frequency band. The hearing loss may be determined on the basis of the measured audiogram and/or equal loudness contour of the user. The method may include determining the band-specific compression control functions on the basis of the hearing loss per frequency band. For instance, in a frequency band (e.g. in each frequency band) a gain value, or gain values, of the band-specific compression control function may be chosen on the basis of the hearing loss in that frequency band. For instance, the higher the hearing loss, the lower the gain may be chosen. For example, a gain value for magnitude values of the audio signal above the knee point may be chosen on the basis of the hearing loss in that frequency band. Alternatively, or additionally, in a frequency band (e.g. in each frequency band) the position (magnitude value) of the knee point may be determined on the basis of the hearing loss in that frequency band. For example, the higher the hearing loss, the lower the knee point may be chosen.

Optionally, the method comprises, e.g. before the determining of the frequency spectrum, amplifying the audio signal such that a lowest sound level of the audio signal is above an auditory threshold of a user of the wearable audio device. The amplification of the audio signal may hence be executed in the time domain. Amplifying the audio signal may be performed using an amplification factor that is smoothed over time to avoid sudden changes in amplification. A linear amplifier may for instance be used to amplify the audio signal. Additionally, or alternatively, the amplification of the audio signal may be executed in the frequency domain. Amplification in the frequency domain may include applying a band-specific amplification factor per frequency band. The band-specific amplification factor may e.g. be determined on the basis of the hearing loss in that frequency band. After the initial amplification, the audio signal may be compressed in the frequency domain, in accordance with the user-specific frequency band-specific compression control function.

Optionally, the auditory threshold is determined based on the measured audiogram of the user.

Optionally, each frequency band-specific compression control function includes a predetermined frequency band-specific knee point. The knee points can be different for different frequency bands. A processing unit may modify an input audio signal, based on the predetermined knee point of the compression control function, particularly by applying a gain to the audio signal input to the processing unit. The compression gain may be defined as a ratio between a magnitude of the output signal and a magnitude of the input signal. A magnitude value of the audio signal below the predetermined knee point for that frequency band may be passed through unaltered, e.g. by applying unity gain, or be increased, e.g. by applying a gain larger than 1. A magnitude value of the audio signal above the predetermined knee point for that frequency band may be decreased, to gain inferior to 1, or in any case smaller than the amplification below the knee point. The knee point defines a transition value or transition range of magnitude values, where the compression gain changes, for example from a unity compression gain for a range of magnitude values of the audio signal that are to be unaltered to a compression gain smaller than one for a range of magnitude values of the audio signal that are to be decreased. The knee point may be a transition range, i.e. a soft knee, for providing a smooth transmission. The frequency band-specific compression control function may include multiple knee points. The compression control function may be progressive above the knee point. In a progressive compression control function the gain monotonically decreases above the knee point.

Optionally, the frequency band-specific knee points are predetermined based on the audiogram of the user. Hence, the frequency band-specific knee points may further be user-specific. The knee points may be stored on a storage device of the wearable audio device, and may optionally be adjustable by the user.

Optionally, each frequency band-specific compression control function includes a predetermined band-specific compression ratio. Each frequency band-specific compression control function can include a predetermined compression ratio above the knee point. The compression ratios can be different for different frequency bands. Optionally, the frequency band-specific compression ratios are predetermined based on the audiogram of the user. Hence, the frequency band-specific compression ratios may further be user-specific. The compression ratios may be stored on a storage device of the wearable audio device, and may optionally be adjustable by the user.

Optionally, the frequency band-specific compression control functions are each represented by a respective linear combination of a finite set of basis functions. This way, the compression control functions can be stored efficiently.

Optionally, the frequency band-specific compression control functions are each represented by a respective finite set of Taylor series coefficients. A Taylor series of a finite number of terms may for example be used.

Optionally, the frequency spectrum of the audio signal corresponds to a Fast Fourier Transform (FFT) of the temporal audio signal. A modified audio signal may be determined corresponding to an Inverse Fast Fourier Transform (IFFT) of the modified frequency spectrum of the audio signal. The frequency spectrum may particularly be obtained from a time frame of the audio signal of N samples, wherein N is preferably a power of two such as 128, 256, 512, 1024. The time frame may be at most five milliseconds.

Optionally, the frequency spectrum includes at least 32 frequency bands, preferably at least 64 frequency bands, more preferably at least 128frequency bands, most preferably at least 256 frequency bands. This can for example be obtained by a 512 point FFT.

Optionally, the audio signal is processed by the signal processor in real-time. In particular, the processing of the audio signal may be perceptively instantaneous, e.g. latency may be at most 8 ms. However, because of a very short timeframe used in the spectral processing, for example between 2 and 4 ms, the compression method may be considered virtually free of an attack time and release time. It will be appreciated that in conventional systems the attack and release time is (much) larger than the latency, whereas in the present system the attack and release time is (much) smaller than the latency.

Optionally, the audio signal is processed by the signal processor through a single processing channel. Hence, the method may not include multiple, e.g. parallel, processing paths. The audio signal may be divided into finite time frames which are processed successively. The time frames may be partly overlapping, i.e. having a number of samples in common.

Optionally, the frequency spectrum of the audio signal is determined using other methods than FFT, such as DFT, sliding window DFT, wavelet analysis, or the like. Preferably, the frequency spectrum includes at least 256 frequency bands.

According to a further aspect, a wearable audio device is provided, comprising an audio signal processor configured for processing an audio signal according to a method as described herein. The wearable audio device may include an in-ear component, e.g. an earbud, for being inserted into a hearing canal of a user. The wearable audio device may particularly be hearing aid. The wearable audio device may also be an earphone, e.g. an in-earphone, on-earphone, or over-earphone, for playing music.

It will be appreciated that any of the aspects, features and options described herein can be combined. It will particularly be appreciated that any of the aspects, features and options described in view of the method apply equally to the wearable hearing device, and vice versa.

### BRIEF DESCRIPTION OF THE DRAWINGS

Embodiments of the present invention will now be described in detail with reference to the accompanying drawings in which:

FIG. 1 shows a schematic example of a processing unit of a wearable audio device;

FIG. 2 shows an example of a wearable audio device;

FIG. 3 shows an example of a flow chart;

FIG. 4 shows an example of a frequency band-specific gain function.

### DETAILED DESCRIPTION

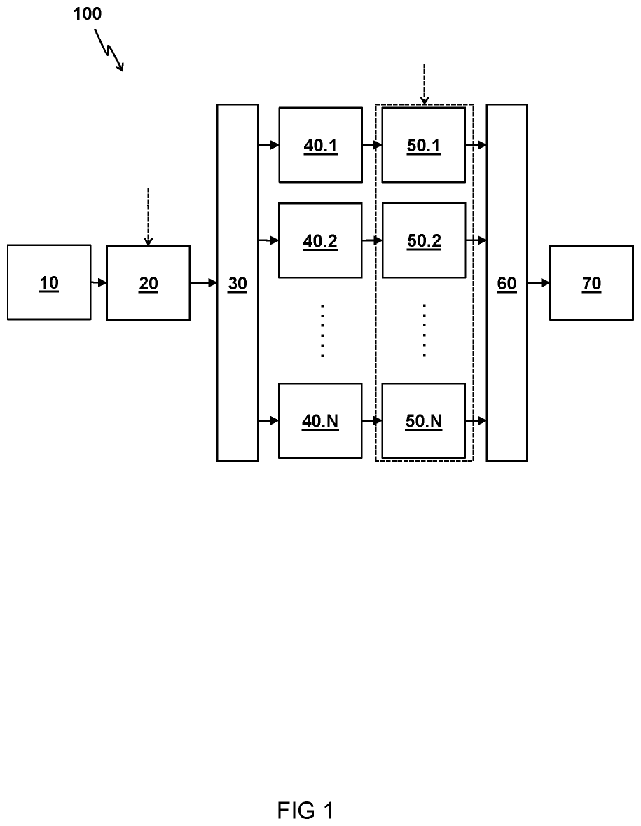

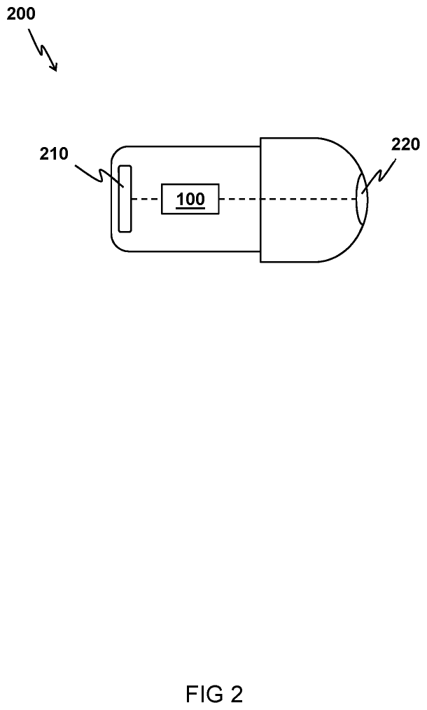

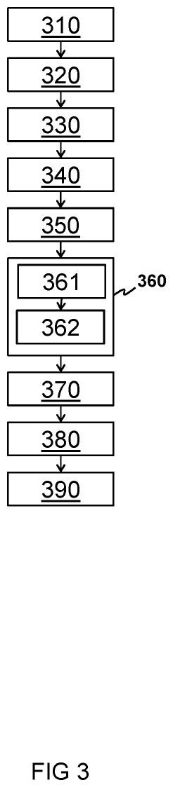

FIG. 1 shows a schematic example of a processing unit 100 of a wearable audio device, particularly a hearing aid, an earphone, e.g. an in-earphone, on-earphone, or over-earphone. FIG. 2 shows an example of a wearable audio device 200, such as a hearing aid, an earphone, e.g. an in-earphone, on-earphone, or over-earphone. FIG. 3 shows an example of a flow chart of a method 300 for compressing a dynamic range of an audio signal. The processing unit 100 comprises an analog to digital converter 10 configured for receiving 310 an analog audio signal, e.g. from a microphone 210 of the wearable audio device, and converting 320 the analog audio signal to a digital audio signal. The audio signal is divided 330 into multiple time frame signals. For example the digital audio signal may be divided into successive time frame signals, either overlapping or non-overlapping, that are, at least partly, separated in time. Each time frame signal may be represented by a finite number of samples, particularly 2N samples wherein 2N is a power of 2, such as 256, 512 or 1024. The digital time frame signals are in this example processed consecutively through a single processing channel of the processing unit 100.

In this example, the processing unit 100 includes an amplifier 20 configured for amplifying 340 the time-domain digital audio signal. The time-domain audio signal is particularly amplified such that a sound level is above an auditory threshold of a user of the wearable audio device. Hereto, the amplifier may receive user-information, indicative of the user-specific auditory thresholds. The auditory threshold may be frequency-dependent. Hence, for example, the amplifier may amplify the audio signal such that a softest sound level is above a lowest auditory threshold. The user-specific auditory thresholds may be obtained from a measured audiogram. It will be appreciated that amplification of the audio signal may also be executed in the frequency domain.

A frequency spectrum of each time frame signal is determined 350 by a first transformation module 30. The first transformation module 30 particularly determines a Fourier transform of the time domain audio signal, e.g. implemented by a Fast Fourier Transform (FFT) algorithm. The frequency spectrum is determined over a plurality of different frequency bands, particularly over N different frequency bands, wherein N is preferably at least 256.

Each time frame may for instance be, or span, at most five milliseconds, such as in a range of two to four milliseconds, e.g. two milliseconds, three milliseconds or four milliseconds. While relatively short time frames may provide a relatively low spectral resolution, it does enable a fast temporal response of the compression. Such relatively short frames furthermore allow for quick, e.g. real-time, compression that quickly responds to level changes in the audio signal. The relatively short length of the time frames, such as less than five milliseconds, furthermore minimizes temporal distortions when processing the audio signal in the spectral domain. Processing of the digital audio signal in the spectral domain may involve filtering of the spectral magnitudes only, and leaving the spectral phase unaltered. Using short time frames minimizes the disassociation between processed amplitude and the unaltered phase.

The processing unit 100 further comprises a compression module 40 for compressing 360 a dynamic range of the audio signal in the frequency-domain audio signal. The compression module 40 is particularly arranged for reducing a magnitude of the audio signal according to a predetermined user-specific compression control function. The user-specific compression control function may be determined based on a measured audiogram of the user.

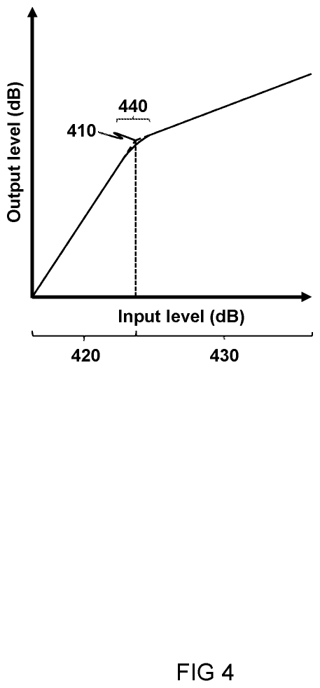

The compression module 40 comprises a plurality of magnitude detectors 40.1-40.N. Each magnitude detector 30.n is associated with a frequency band of the frequency spectrum of the audio signal, and is configured to detect 361 a magnitude value of the audio signal in its associated frequency band. After having detected the magnitude values for the plurality of frequency bands, the magnitude value may be modified 362 according to the predetermined user-specific compression control function by a compressor 50. The user-specific compression control function may be a digital filter, e.g. a frequency dependent gain, to be applied to the frequency spectrum of the audio signal. For each frequency band, independent of the other frequency bands, a frequency band-specific gain function may be defined. The frequency-dependent gain function determines an output magnitude value of the audio signal output by the compressor 50 as a function of the input magnitude value of the audio signal input to the compressor 50. FIG. 4 shows an example of a frequency band-specific gain function 400. The frequency band-specific gain functions may be predetermined based on an audiogram of the user. Each frequency band- specific gain function may particularly include a user-specific knee point 410, e.g. predetermined based on the user's audiogram. For magnitude values 420 below a predetermined knee point a first gain value may be selected for modifying the audio signal magnitude, e.g. a gain value equal to or larger than 1; and for magnitude values 430 above the predetermined knee point a second gain value may be selected, e.g. a gain value less than 1 or in any case smaller than the first gain value. For example, a magnitude of the audio signal may be determined by the magnitude detector 40.n for each of a plurality of frequency bands of the frequency spectrum, wherein, in case the magnitude value of an audio signal in a frequency band exceeds the predetermined knee point, the magnitude value of said band is compressed in the frequency domain according to the user-specific frequency-dependent gain value. The gain value may be represented as a compression ratio between a magnitude of the output of the compressor 50.n and a magnitude of the input of the compressor 50.n. The magnitude of the audio signal may be amplified e.g. in case the magnitude is below a auditory threshold of the user. Hence, additionally or alternatively to the time-domain amplifier 20, the audio signal may also be amplified in the frequency domain by each of compressors 50.n, e.g. by selecting an appropriate gain.

The frequency band-specific gain function may be a smooth function of amplitude, e.g. the knee point may be a transition range 440, i.e. a soft knee. It will be appreciated that the frequency band-specific compression control function may include multiple knee points. The frequency band-specific compression control function may be progressive, i.e. provide a monotonically decreasing gain with increasing input magnitude value.

The compressed frequency domain audio signal can subsequently be converted back 370 to the time domain by a second transformation module 60. Here, the conversion back to the time domain effectively is the inverse of the dividing into multiple time frame signals at 330 and the frequency spectrum determination of each time frame signal at 350. The back conversion 370 can hence include applying an Inverse Fast Fourier Transform (IFFT) algorithm to obtain time frame signals and rearranging those time frame signals into a smooth signal that is true to the original temporal structure. The resultant digital time-domain audio signal is, here, converted 380 to an analog audio signal by a digital-to-analog converter 70, e.g. to be transmitted 390 to an output speaker 220.

Herein, the invention is described with reference to specific examples of embodiments of the invention. It will, however, be evident that various modifications and changes may be made therein, without departing from the essence of the invention. For the purpose of clarity and a concise description, features are described herein as part of the same or separate embodiments, however, alternative embodiments having combinations of all or some of the features described in these separate embodiments are also envisaged.

However, other modifications, variations, and alternatives are also possible. The specifications, drawings and examples are, accordingly, to be regarded in an illustrative sense rather than in a restrictive sense.

For the purpose of clarity and a concise description, features are described herein as part of the same or separate embodiments, however, it will be appreciated that the scope of the invention may include embodiments having combinations of all or some of the features described.

In the claims, any reference signs placed between parentheses shall not be construed as limiting the claim. The word ‘comprising’ does not exclude the presence of other features or steps than those listed in a claim. Furthermore, the words ‘a’ and ‘an’ shall not be construed as limited to ‘only one’, but instead are used to mean ‘at least one’, and do not exclude a plurality. The mere fact that certain measures are recited in mutually different claims does not indicate that a combination of these measures cannot be used to an advantage.

1. A method for compressing a dynamic range of an audio signal in a wearable audio device, the method comprising:
determining a frequency spectrum of the audio signal over a plurality of frequency bands,
for each of the plurality of frequency bands, determining a magnitude value of the frequency spectrum, and adjusting the magnitude value according to a predetermined frequency band-specific compression control function,
wherein the band-specific compression control functions are user-specific.

2. The method of claim 1, wherein the band-specific compression control functions are predetermined based on a measured audiogram of a user of the wearable audio device.

3. The method of claim 1, further comprising amplifying the audio signal such that a lowest sound level of the audio signal is above an auditory threshold of a user of the wearable audio device, wherein the auditory threshold is optionally determined based on the measured audiogram of the user.

4. The method of claim 1, wherein each frequency band-specific compression control function includes a predetermined frequency band-specific knee point.

5. The method of claim 4, wherein each frequency band-specific compression control function includes a predetermined band-specific compression ratio.

6. The method of claim 4, wherein the frequency band-specific knee points and/or compression ratios are predetermined based on the audiogram of the user.

7. The method of claim 1, wherein the frequency band-specific compression control functions are each represented by a respective linear combination of a finite set of basis functions.

8. The method of claim 1, wherein the frequency band-specific compression control functions are each represented by a respective finite set of Taylor series coefficients.

9. The method of claim 1, wherein the frequency spectrum of the audio signal corresponds to a Fast Fourier Transform (FFT) of the audio signal.

10. The method of claim 9, wherein the frequency spectrum includes at least 32 frequency bands.

11. The method of claim 1, wherein the frequency spectrum of the audio signal is determined using DFT, sliding window DFT, wavelet analysis, or the like.

12. The method of claim 1, wherein the audio signal is processed in real-time.

13. The method of claim 1, wherein the audio signal is processed through a single processing channel.

14. A wearable audio device comprising an audio signal processor configured for processing an audio signal according to the method of claim 1.

15. The method of claim 1, wherein the wearable audio device is a hearing aid.

16. The method of claim 2, further comprising amplifying the audio signal such that a lowest sound level of the audio signal is above an auditory threshold of a user of the wearable audio device, wherein the auditory threshold is optionally determined based on the measured audiogram of the user.

17. The method of claim 5, wherein the frequency band-specific knee points and/or compression ratios are predetermined based on the audiogram of the user.

18. The method of claim 10, wherein the frequency spectrum includes at least 64 frequency bands.

19. The method of claim 18, wherein the frequency spectrum includes at least 256 frequency bands.

20. A wearable audio device comprising an audio signal processor configured for processing an audio signal according to the method of claim 1.
